(19) United States
(12) Patent Application Publication
(10) Pub. No.: US 2026/0344918 A1
(43) Pub. Date: Nov. 5, 2026

(54) Trackable Food Servers and Tracking Systems for Food Delivery

(71) Applicant: Aladdin Temp-Rite, LLC, Hendersonville, TN (US)

(72) Inventors: David R. Gordon, Nashville, TN (US); Curt Griggs, Hendersonville, TN (US)

(21) Appl. No.: 19/663,410

(22) Filed: Apr. 30, 2026

Related U.S. Application Data
(60) Provisional application No. 63/800,319, filed on May 5, 2025.

(51) Int. Cl. A47G 19/02; G01S 1/04

(52) U.S. Cl. CPC A47G 19/02; G01S 1/0423

(57) ABSTRACT

A food server includes a dome configured to cover a base. The dome has an inner wall, an outer wall, and a tracking module. The outer wall is secured to the inner wall to define an enclosure therebetween. The tracking module is positioned with the enclosure. The tracking module transmits a tracking signal including a unique identifier. The tracking signal is configured to be received by a scanner positioned outside of the food server.

### CROSS-REFERENCE TO RELATED APPLICATIONS

This application claims priority to, and benefit of, U.S. Provisional Patent Application Serial No. 63/800,319, filed May 5, 2025. The entire contents of the above application is hereby incorporated by reference.

### BACKGROUND

### 1.Technical Field

The present disclosure relates to food services and, more specifically, to trackable food servers and tracking systems for food delivery.

### 2. Discussion of Related Art

When food is cooked and then served to remotely located recipients, such as in hospitals, managed care facilities, hotels, and other institutional settings, it may be necessary to ensure the correct food gets to the correct recipient. For example, some recipients may have dietary restrictions or food allergies.

In some settings, tracking food delivery times, accuracy of delivery, and actual delivery may be important to track. For example, food service may be provided by a third-party vendor with payment to the third-party vendor being tied to delivery times, accuracy of delivery, or actual delivery.

### SUMMARY

This disclosure relates generally to food servers and tracking systems for verifying food delivery.

In an aspect of the present disclosure, a food server includes a dome configured to cover a base. The dome includes an inner wall, an outer wall, and a tracking module. The outer wall is secured to the inner wall to define an enclosure therebetween. The tracking module is positioned within the enclosure. The tracking module transmits a tracking signal including a unique identifier at a first predetermined timer interval. The tracking signal is configured to be received by a scanner positioned outside of the food server.

In aspects, the tracking module has a first state in which the tracking module emits the tracking signal at the first predetermined time interval and a second state in which the tracking module emits the tracking signal at a second predetermined time interval. The second predetermined time interval may be less than the first predetermined time interval. The tracking module may include a power source. The first predetermined time interval and the second predetermined time interval may be selected such that the power source has a limited life of predetermined duration. The first predetermined time interval may in a range of 1 minute to 60 minutes and the second predetermined time interval may be in a range of 1 second to 60 seconds.

In some aspects, the food server includes a base. The base may be a heat retentive base or a dish. The base may include a base tracking module disposed therein.

In certain aspects, the tracking module is configured to continuously transmit the tracking signal for communication with the scanner. The dome may include an identifying indicia disposed thereon configured for associating the tracking module with a recipient. The identifying indicia may be a machine readable indicia or a human readable denitrifying indicia.

In particular aspects, the tracking module may is attached to the outer wall. The outer wall may have a handle section at the top of the dome. The tracking module may be positioned within the handle section. The enclosure may be filled with an insulative material. The tracking module may be embedded within the insulative material.

In another aspect of the present disclosure, a food delivery system includes a food server and a first scanner. The food server includes a base and a dome. The dome is configured to cover the base. The dome includes an inner wall, an outer wall, and a tracking module. The outer wall is secured to the inner wall to define an enclosure therebetween. The tracking module is positioned within the enclosure. The tracking module transmits a tracking signal including a unique identifier. The first scanner is positioned outside of the food server. The first scanner receives the tracking signal to associate the food server with a recipient within a facility.

In aspects, the system includes a second scanner positioned outside of the food server. The second scanner may receive the tracking signal when the food server is within a predetermined distance from the second scanner. The second scanner may transmit the unique identifier via a module signal. The module signal may be configured to be received by a computer system of the facility for tracking the food server within the facility. The tracking module may have a first state in which the tracking module emits the tracking signal at a first predetermined time interval and a second state in which the tracking module emits the tracking signal at a second predetermined time less than the first predetermined time interval.

In another aspect of the present disclosure, a method of food delivery in a facility includes associating a unique identifier of a tracking module of a food server with a recipient within the facility. The method also includes transmitting a tracking signal to a beacon scanner with the tracking module to track the food server within the facility. The method also includes confirm delivery of the food server to the recipient based on the tracking signal transmitted to the beacon scanner.

In aspects, transmitting the tracking signal includes emitting the tracking signal at a predetermined interval such that a power source of the tracking module has a limited of predetermined duration. Associating the tracking module may include switching the tracking module from a first state to a second state in which the tracking module emits the tracking signal. Confirming delivery of the food server may include switching the tracking module to the first state. The method may also include associating the unique identifier of the tracking module of the food server with a different recipient within the facility after confirming delivery of the food server.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are not necessarily drawn to scale, which are incorporated in and constitute a part of this specification, wherein:

FIG. 1 is a perspective view of a food server provided in accordance with the present disclosure including a base and a dome;

FIG. 2 is a bottom view of a dome of the food server of FIG. 1 with an inner wall removed to show the interior of the outer wall thereof;

FIG. 3 is a top view of the base of FIG. 4 including the inner wall;

FIG. 4 is a cross-sectional view of the dome of FIG. 1;

FIG. 5 is a top perspective view of a tray of the food server of FIG. 1;

FIG. 6 is a bottom perspective view of the tray of FIG. 5;

FIG. 7 is a perspective view of a portion of the bottom of the tray as indiciated in FIG. 6;

FIG. 8 is a schematic view of tracking system for food delivery provided in accordance with the present disclosure; and

FIG. 9 is a flow chart of a method of tracking food delivery provided in accordance with the present disclosure.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

As used herein, the phrase “configured to” describes a related element that must be made, suited by nature, character, or designed for a particular use, purpose, or situation. In contrast, the phrase “capable of” describes a related element that only needs to be suitable for a particular use, purpose, or situation.

As used herein, the term “facility” refers to the building, buildings, or institution including, but not limited to, hospitals, managed care facilities, hotels, special events, hospitality events, and other institutional settings.

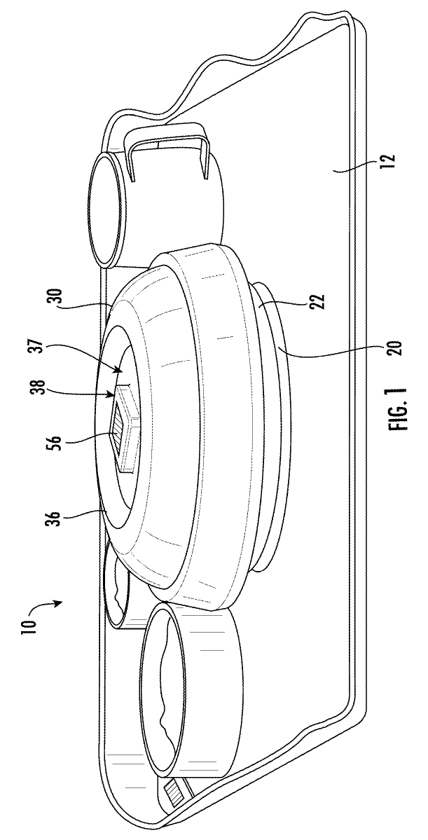

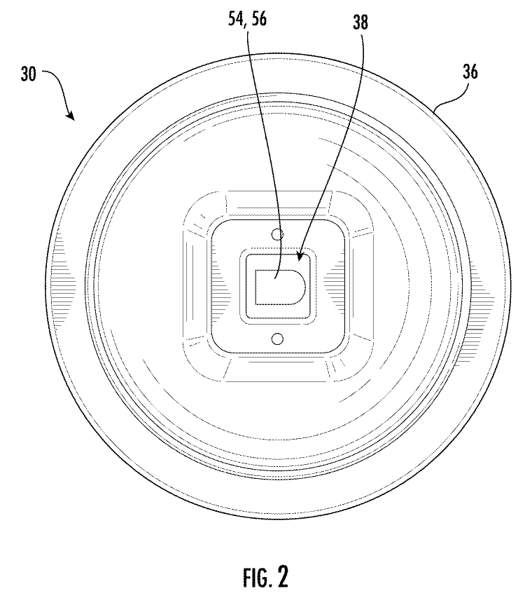

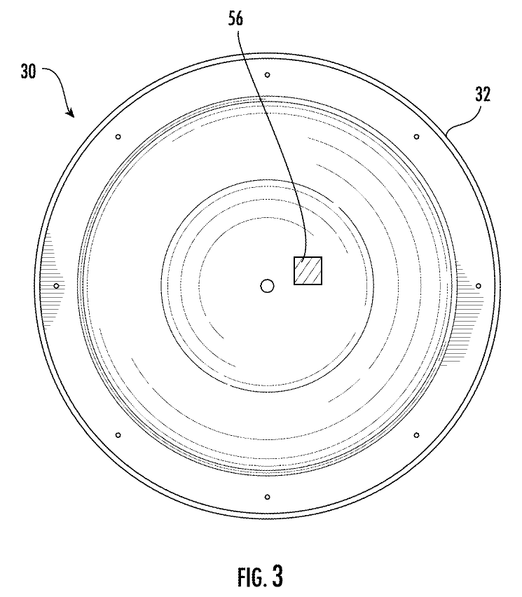

Referring now to FIGS. 1-4, a food server 10 is provided in accordance with the present disclosure. The food server 10 includes a base 20 and a dome 30 that define a cavity therebetween. The cavity is configured to contain food. The base 20 may be a heat retentive base or may be a base without any thermal properties. When the base 20 is a heat retentive base, the cavity may be maintained at a desired temperature by the cooperation of base 20 and the dome 30. In some embodiments, the base 20 may be a dish that receives the dome 30 or is covered by the dome 30 such that the dome 30 covers the dish and rests on a tray 12. In certain embodiments, the base 20 receives a dish thereon. An example of a food server without a tracking module as discussed below is disclosed in U.S. Patent No. 12,226,052.

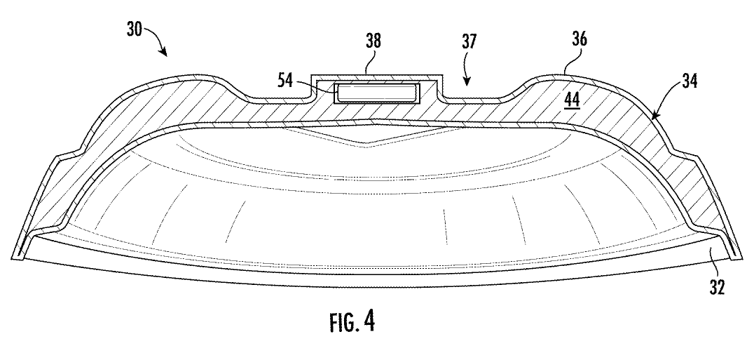

With particular reference to FIG. 4, the dome 30 may be an insulated dome that includes an inner wall 32, an outer wall 36, and an enclosure 34 defined between the inner wall 32 and the outer wall 36. The outer wall 36 may include a handle section 38 at the top of the dome 30. The handle section 38 may protrude from the top of the outer wall 36. In certain embodiments, the handle section 38 may define a recess 37 in the outer wall 36 and protrude from the bottom of the recess 37.

The enclosure 34 may be filled with an insulative material 44. The insulative material 44 may insulate the cavity between the dome 30 and the base 20 when the dome 30 is disposed over the base 20. The insulative material 44 may be an aerogel, an open cell foam, a closed cell foam, an expanding foam, a polyurethane foam, other suitable material, or combinations thereof. In certain embodiments, the insulative material 44 may be in the form of an air void or a vacuum cavity. For example, the enclosure 34 may be absent solid material between the inner wall 32 and the outer wall 36.

The enclosure 34 includes a tracking module 54 disposed therein. The tracking module 54 may be attached to the outer wall 36. In embodiments, the tracking module 54 may be disposed in the insulative material 44 within the handle section 38. Disposing the tracking module 54 within the insulative material 44 may protect the tracking module 54 from temperature variations during service and washing. The tracking module 54 is configured to be in communication with a system outside of the food server 10. The tracking module 54 may be an active tracking module 54 that sends a tracking signal including a unique identifier that is detected by the external system. The tracking module 54 may be a Bluetooth® Low Energy (BLE) transmitter. In some embodiments, the tracking module 54 may include a power source, e.g., a battery, disposed within the tracking module 54. The power source may have a limited life such that the tracking module 54 ceases to transmit after a predetermined amount of time. For example, the limited life may be in a range of a few months to several years, e.g., 3 months to 3 years. Providing the tracking module 54 with a limited life power source may reduce operational costs by eliminating battery replacement, service downtime, and associated labor over the usable life of the food server 10. Additionally or alternatively, tracking modules having limited life power sources enables predictable device performance and simplifies large-scale fleet management by aligning the operational lifetime of the tracking module 54 with planned replacement or refurbishment cycles for institutional food service operations. In some embodiments, limited life power sources may reduce data security risks associated with long-term location tracking by limiting the duration of data generation and retention. For example, limited life power sources may ensure tracking automatically ceases after a defined period without requiring manual deactivation or system intervention.

The tracking module 54 may transmit or link to the external system at predetermined time intervals. The predetermined time intervals may be determined to allow the power source to last the predetermined amount of time, e.g., 2 years or more. The predetermined time intervals may be in a range of 1 second to 60 seconds, e.g., 1, 5, 10, 15, 20, 25, 30, 35, 40, 45, 50, 55, or 60 seconds. In certain embodiments, the tracking module 54 may have a sleep or inactive state and an active state. The tracking module 54 may be in the inactive state after the dome 30 is delivered or returned to a storage room or area. The tracking module 54 may be in an active state when the dome 30 is associated with a particular recipient until it is delivered, washed, or returned to a storage room or area. In the inactive state, the tracking module 54 may transmit at a first predetermined time interval and in the active state, the tracking module 54 may transmit at a second predetermined time interval that is less than the first predetermined time interval. For example, the first predetermined time interval may be in a range of 1 minute to 60 minutes, e.g., 1, 2, 5, 10, 15, 20, 30, 40, 60 minutes, and the second predetermined time interval may be in a range of 1 second to 60 seconds, e.g., 1, 5, 10, 15, 20, 25, 30, 35, 40, 45, 50, 55, or 60 seconds. In some embodiments, the second predetermined time interval may be in a range of 1 minute to 60 minutes, e.g., 1, 2, 5, 10, 15, 20, 30, 40, 60 minutes. In certain embodiments, the first predetermined time interval or the second predetermined time interval may be longer than 60 minutes, e.g., 75 minutes, 90 minutes, or 120 minutes. A shorter second predetermined time interval, e.g., an interval less than or equal to 60 seconds, may allow for live tracking of the food server 10. A longer second predetermined time interval, e.g., longer than 60 seconds, may allow for tracking of the food server 10 while minimizing data collection necessary to track the food server 10. Minimizing data collection may reduce load on enterprise computer systems and reduce associated data storage costs. Having the active and inactive state may allow the tracking module to transmit for a longer amount of time before the power source is exhausted. In particular embodiments, the power source is rechargeable, e.g., inductively rechargeable. In certain embodiments, the power source is a non-rechargeable battery, e.g., a lithium-ion button battery. An example of a suitable tracking module may be, but is not limited to, an EMBC20 or EMBP01 available from HID Global.

As noted above, the tracking module 54 may be an active tracking module. An active tracking module is a module that actively emits or transmits a signal regardless of presence of an external reader, scanner, or antenna, e.g., a BLE module. For example, the tracking module 54 may continuously emit or transmit a tracking signal. In some embodiments, the tracking module 54 may actively transmit the tracking signal at the predetermined time intervals of the active state and the inactive state. In such embodiment, the tracking module 54 may not transmit a tracking signal between the predetermined time intervals. In certain embodiments, the tracking module 54 may be a passive tracking module, e.g., an RFID tag. A passive tracking module is a module that must be activated by an external reader, scanner, or antenna in close proximity to the tracking module. In addition, an active tracking module may pair or receive communications from an external system. For example, the external system may switch the tracking module 54 between an active state or an inactive state when certain criteria of the tracking module 54 are met within the external system.

Referring briefly back to FIG. 1, the outer wall 36 of the dome 30 may include identifying indicia 56 on or in the handle section 38 to allow the tray to be associated with a particular recipient at the time of plating, as explained in greater detail below. The identifying indicia 56 may be a bar code, a QR code, or other visual indicia that can be scanned or read. The identifying indicia 56 may be machine readable, human readable, or both. The identifying indicia 56 may be laser etched or be a sticker or other label on the outer wall 36 or the inner wall 32 of the dome 30. In some embodiments, the identifying indicia 56 may be a passive module disposed in or on the handle section 38. The passive module may be scanned or activated by an external antenna to associate the tracking module 54 with the particular patient. The passive module may be an RFID tag. In certain embodiments, the localized scanner may be used to associate a particular tracking module 54 in a dome 30 to a particular patient in a confined space with a plurality of tracking modules 54. The localized scanner may be configured to receive a transmission only from a tracking module 54 positioned within a particular space or distance from the localized scanner. For example, the unique identifier may only be collected from the tracking module 54 when the food server 10 is detected as being within a predetermined distance from the scanner. The predetermined distance may be in a range of a few inches to several feet, e.g., 6 inches to 3 feet.

As detailed above, the tracking module 54 is provided in the dome 30 of the server 10. In certain embodiments, the server 10 includes a tray 12 and the tracking module 54 may be disposed in or on the tray 12. In such embodiments, the server 10 may not include the base 20 and/or the dome 30. Including the tracking module 54 in the tray 12 may allow for tracking of food delivery of items not including a dome 30, e.g., beverages, cold items, items disposed in disposable containers. The tracking module 54 disposed in or on the tray 12 may be an active or passive tracking module. The tray 12 may include identifying indicia on a surface of the tray 12 to allow the tray 12 to be associated with a particular recipient at time of plating in the vicinity of a plurality of other trays.

Referring to FIG. 1, in embodiments, the base 20 may include a tracking module 54 disposed therein. The base 20 may have an outer shell 22 and an inner shell (not shown). In embodiments, the outer shell 22 and the inner shell secure together to define a chamber (not shown) therebetween. In certain embodiments, the tracking module 54 may be positioned between the outer shell 22 and the inner shell 24 within the chamber. The chamber may be filled with a buffer material to provide conductive heat transfer to the plate on the base 20. The base 20 may also include an identifying indicia 56 on a visible portion of the base 20. For example, the identifying indicia 56 may be located on inner shell.

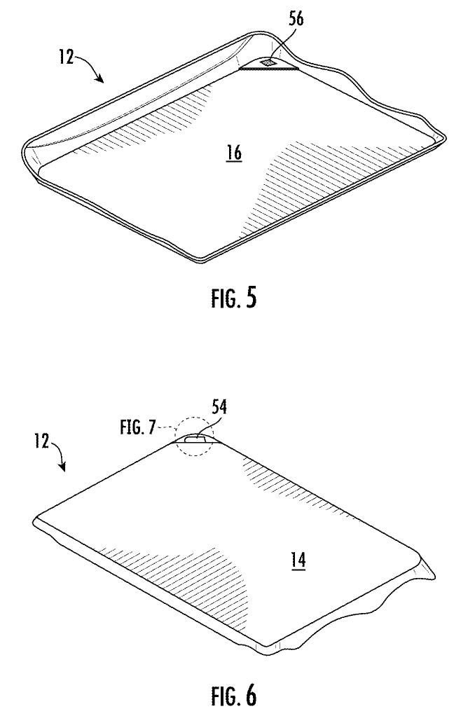

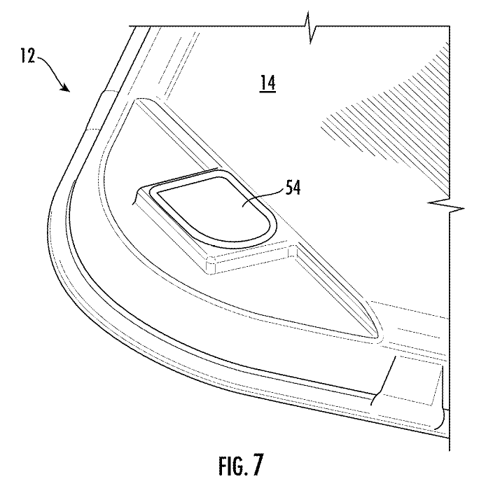

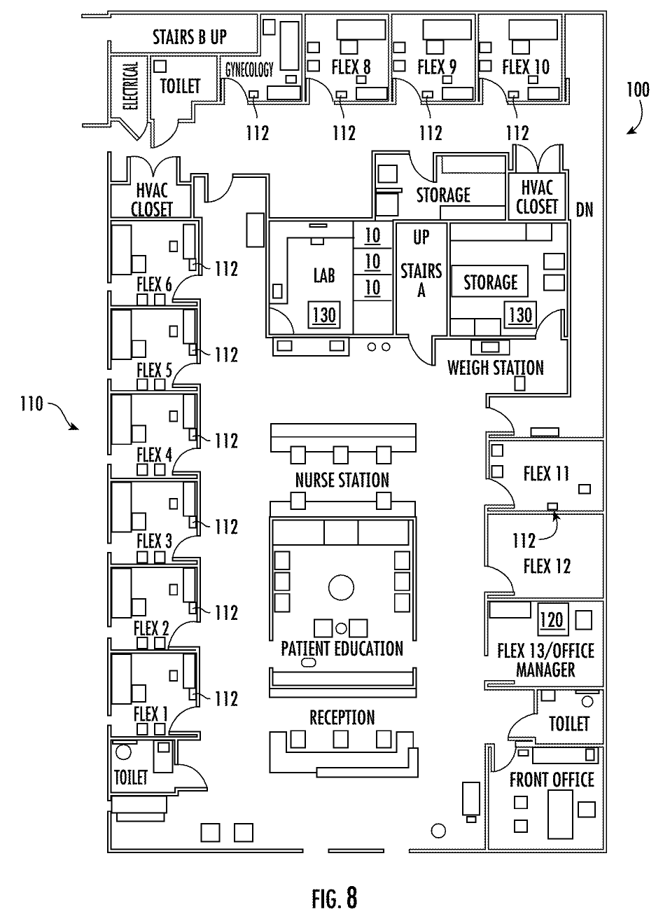

Referring to FIGS. 5-7, in embodiments, the tray 12 may include a tracking module 54 disposed on a bottom side 14 of the tray 12. The tray 12 may have an identifying indicia 56 on a visible portion of the tray 12. For example, the indicia 56 may be located on a top side 16 of the tray 12.

With reference now to FIG. 8, a system for tracking food delivery is provided in accordance with the present disclosure and is referred to generally as system 100. The system 100 includes a plurality of food servers 10 having a tracking module 54, a beacon infrastructure 110, and a computer system 120. The beacon infrastructure 110 includes a plurality of beacon scanners 112 that are disposed about the facility in which the food servers 10 will be tracked. Each beacon scanner 112 of the beacon infrastructure 110 is configured to receive a tracking signal transmitted from the tracking modules 54 and transmit a module signal to the computer system 120. The beacon scanners 112 may be in direct communication with the computer system 120 or may be connected to the computer system 120 via a computer network 122. The computer network 122 may be wired, wireless, or combinations thereof. The computer system 120 may receive the module signals from the beacon infrastructure 110 to locate each of the tracking modules 54 within the facility.

The system 100 may include localized scanners 130 in one or more locations within the facility. The localized scanners 130 may be used to identify a specific tracking module 54 in an area or room with a plurality of tracking modules 54. For example, the localized scanners 130 may be in a plating area, a cleaning area, or a storage area. The localized scanners 130 may be used to associate a tracking module 54 with a particular recipient. The localized scanners 130 may be used to confirm cleaning of a particular tracking module 54. In some embodiments, the localized scanners 130 may be used to switch a state of the tracking module 54, e.g., between an inactive state and an active state. The localized scanners 130 may be in a fixed location or may be handheld devices.

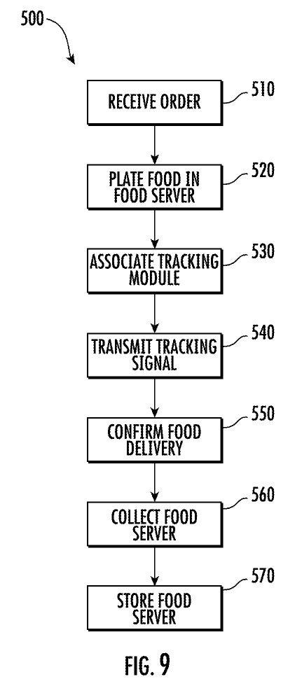

Referring to FIGS. 8 and 9, a method of tracking food delivery is provided in accordance with the present disclosure and is referred to generally as method 500. The method 500 is described with reference to the food server 10 and the system 100 of FIGS. 1-8. The method 500 may include receiving an order for one or more recipients located within a facility (Step 510). The order may come through an order system connected to the computer system 120. When the order is completed, the order is plated into a food server 10 (Step 520). As the order is plated, the tracking module 54 in the dome 30 of the food server 10 is associated with the recipient of the order (Step 530). The tracking module 54 may be associated with the recipient by a localized scanner 130. The localized scanner 130 may scan an indicia 56 of the dome 30 to associate the dome 30 with the recipient. In some embodiments, the localized scanner 130 activates a passive module of the indicia 56 to associate the dome 30 with the recipient. In certain embodiments, the localized scanner 130 may transition the tracking module 54 from an inactive state to an active state. The food server 10 is then loaded into a cart or taken to the recipient. The food server 10 may be loaded onto the cart with a plurality of other food servers 10.

The food server 10 loaded onto the cart, the tracking module 54 may ping or transmit tracking signals to beacon scanners 112 of the beacon infrastructure 110 such that the beacon scanners 112 locate the tracking module 54 within the facility (Step 540). The tracking module 54 is tracked throughout the facility until it is tracked to the location associated with the associated recipient. When the tracking module 54 is tracked to the associated recipient, e.g., in room 1, the delivery of the food server 10 may be confirmed in the computer system 120 (Step 550). When delivery of the food server 10 is confirmed, other statistics of the food delivery may be determined. For example, the time for delivery may be recorded. When delivery is confirmed, the computer system 120 may provide a signal to the tracking module 54 to transition to an inactive state. A localized scanner 130 may be used to confirm delivery. When a localized scanner 130 is used to confirm delivery, the localized scanner 130 may provide indicia indicating that the correct food server 10 was delivered to the recipient. In certain embodiments, the recipient may sign or otherwise acknowledge delivery on the localized scanner 130. In some embodiments, a recipient may have a recipient tracking module, e.g., a wristband or a name tag. In such embodiments, delivery may be confirmed by determining the location of the tracking module 54 relative to a recipient tracking module. In certain embodiments, the tracking module 54 may link with the recipient tracking module to confirm delivery to the correct recipient. The linking or location determination of the tracking module 54 relative to the recipient tracking module may be automatic or manual.

When the recipient is done with the food server 10, the food server 10 may be picked up and delivered to a dishwashing or cleaning area (Step 560). When the food server 10 is cleaned, a localized scanner 130 may be used to indicate return of the food server 10 and/or transition the food server to an inactive state. After cleaning, the food server 10 may be taken to a storage area or to the plating area for subsequent use. In some embodiments, after cleaning, the unique identifier of the tracking module 54 may be re-associated with a different recipient within the facility for a subsequent food delivery (Step 570).

Although the method steps are described in a specific order, it should be understood that other steps may be performed before, in between, or after described steps. Described steps may be adjusted so that they occur at slightly different times, or the described steps may occur in any order unless otherwise specified.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A food server comprising:
a dome configured to cover a base, the dome comprising:
an inner wall;
an outer wall secured to the inner wall to define an enclosure therebetween; and
a tracking module positioned within the enclosure, the tracking module transmitting a tracking signal including a unique identifier at a first predetermined time interval, the tracking signal configured to be received by a scanner positioned outside of the food server.

2. The food server according to claim 1, wherein the tracking module has a first state in which the tracking module emits the tracking signal at the first predetermined time interval and a second state in which the tracking module emits the tracking signal at a second predetermined time interval, the second predetermined time interval less than the first predetermined time interval.

3. The food server according to claim 2, wherein the tracking module includes a power source, the first predetermined time interval and the second predetermined time interval selected such that the power source has a limited life of predetermined duration.

4. The food server according to claim 2, wherein the first predetermined time interval is in a range of 1 minute to 60 minutes and the second predetermined time interval is in a range of 1 second to 60 seconds.

5. The food server according to claim 1, further comprising a base, the base being a heat retentive base or a dish.

6. The food server according to claim 1, wherein the tracking module is configured to continuously transmit the tracking signal for communication with the scanner.

7. The food server according to claim 1, wherein the dome includes an identifying indicia disposed thereon configured for associating the tracking module with a recipient.

8. The food server according to claim 7, wherein the identifying indicia is a machine readable or a human readable identifying indicia.

9. The food server according to claim 1, wherein the tracking module is attached to the outer wall.

10. The food server according to claim 1, wherein the outer wall has a handle section at the top of the dome, the tracking module positioned within the handle section.

11. The food server according to claim 1, wherein the enclosure is filled with an insulative material.

12. The food server according to claim 11, wherein the tracking module is embedded within the insulative material.

13. A food delivery system comprising:
a food server comprising:
a base; and
a dome configured to cover the base, the dome comprising:
an inner wall;
an outer wall secured to the inner wall to define an enclosure therebetween; and
a tracking module positioned within the enclosure, the tracking module transmitting a tracking signal including a unique identifier; and
a first scanner positioned outside of the food server, the first scanner receiving the tracking signal to associate the food server with a recipient within a facility.

14. The system according to claim 13, further comprising a second scanner positioned outside of the food server, the second scanner receiving the tracking signal when the food server is within a predetermined distance from the second scanner, the second scanner transmitting the unique identifier via a module signal, the module signal configured to be received by a computer system of the facility for tracking the food server within the facility.

15. The system according to claim 13, wherein the tracking module has a first state in which the tracking module emits the tracking signal at a first predetermined time interval and a second state in which the tracking module emits the tracking signal at a second predetermined time interval less than the first predetermined time interval.

16. A method of food delivery in a facility comprising:
associating a unique identifier of a tracking module of a food server with a recipient within the facility;
transmitting a tracking signal to a beacon scanner with the tracking module to track the food server within the facility; and
confirming delivery of the food server to the recipient based on the tracking signal transmitted to the beacon scanner.

17. The method according to claim 16, wherein transmitting the tracking signal includes emitting the tracking signal at a predetermined interval such that a power source of the tracking module has a limited life of predetermined duration.

18. The method according to claim 16, wherein associating the tracking module includes switching the tracking module from a first state to a second state in which the tracking module emits the tracking signal.

19. The method according to claim 18, wherein confirming delivery of the food server includes switching the tracking module to the first state.

20. The method according to claim 16, further comprising associating the unique identifier of the tracking module of the food server with a different recipient within the facility after confirming delivery of the food server.
